(19) United States
(12) Patent Application Publication
(10) Pub. No.: US 2015/0066188 A1
(43) Pub. Date: Mar. 5, 2015

(54) SHEET PROCESSING SYSTEM AND SHEET PROCESSING METHOD

(71) Applicant: Kabushiki Kaisha Toshiba, Tokyo (JP)

(72) Inventor: Ley Kim Ang, Yokohama (JP)

(21) Appl. No.: 14/474,531

(22) Filed: Sep. 2, 2014

(30) Foreign Application Priority Data
Sep. 4, 2013 (JP) 2013-183521

(51) Int. Cl. B65H 43/00; G05B 15/02

(52) U.S. Cl. CPC B65H 43/00; G05B 15/02
USPC 700/127

(57) ABSTRACT

According to one embodiment, a sheet processing system includes estimation means which, based on bundle information relating to a number of sheets by denomination of a plurality of the sheets included in a bundle, and weight information of the sheets by denomination, estimates a weight of the bundle, to output estimated weight information, measurement means for measuring a weight of the bundle, to output measured weight information; comparison means for comparing the estimated weight information and the measured weight information, and control means for controlling a processing of the bundle, based on a comparison result of the estimated weight information and the measured weight information.

### CROSS-REFERENCE TO RELATED APPLICATION

This application is based upon and claims the benefit of priority from Japanese Patent Application No. 2013-183521, filed on Sep. 4, 2013; the entire contents of which are incorporated herein by reference.

### FIELD

Embodiments described herein relate generally to a sheet processing system and a sheet processing method.

### BACKGROUND

A sheet processing apparatus is known, in which a plurality of sheets (a note such as a banknote) composed of a plurality of kinds are collectively inserted, and which sorts the sheets based on a denomination or a state such as a fouling degree and a direction of a sheet, and stacks the respective sorted sheets into a plurality of stackers.

The sheet processing apparatus assembles sheets of the same kind stacked in a stacker into a bundle (100 sheets×10 sheaves), and discharges the bundle on a conveyor. The conveyor conveys the sheets assembled in the bundle to a package processing structure. The package processing structure measures a weight of the bundle by a weight measuring apparatus, verifies the number of the sheets of the bundle based on the measurement result, and packages the bundle. For example, the package processing structure compares weight information (a weight for each sheet×the number of sheets) corresponding to the number of sheets with a measured weight of the bundle, to verify the number of the sheets of the bundle.

When a bundle includes only sheets of one kind, the number of the sheets of the bundle can be verified by the above-described method. However, when a bundle includes sheets of a plurality of kinds, and a weight is different for each kind of a sheet, a weight of the bundle does not become uniform, even in the case of a bundle of the same number of sheets. That is, when a bundle includes sheets of a plurality of kinds, it is difficult to verify the number of the sheets included in the bundle by the above-described method.

### BRIEF DESCRIPTION OF THE DRAWINGS

FIG. 1 is a diagram schematically showing an example of a whole configuration of a sheet processing system according to an embodiment;

FIG. 2 is a sectional view schematically showing an example of a whole configuration of the sheet processing apparatus according to the embodiment;

FIG. 3 is a sectional view showing in detail an example of the whole configuration of the sheet processing apparatus according to the embodiment;

FIG. 4 is a sectional view showing by enlargement the supply/determination unit, the loading unit, the stacking unit of the sheet processing apparatus according to the embodiment;

FIG. 5 is a block diagram showing an example of a control system of the sheet processing apparatus according to the embodiment;

FIG. 6 is a flow chart showing an example of weight estimation of a bundle, weight measurement of the bundle, and package processing control of the bundle according to the embodiment; and

FIG. 7 is a diagram showing a calculation example of an estimated weight of a bundle according to the embodiment.

### DETAILED DESCRIPTION

According to one embodiment, there is provided a sheet processing system including estimation means which, based on bundle information relating to a number of sheets by the denomination of a plurality of the sheets included in a bundle, and weight information of the sheets by denomination, estimates a weight of the bundle, to output estimated weight information, measurement means for measuring a weight of the bundle, to output measured weight information; comparison means for comparing the estimated weight information and the measured weight information, and control means for controlling a processing of the bundle, based on a comparison result of the estimated weight information and the measured weight information.

Hereinafter, embodiments will be described with reference to the drawings.

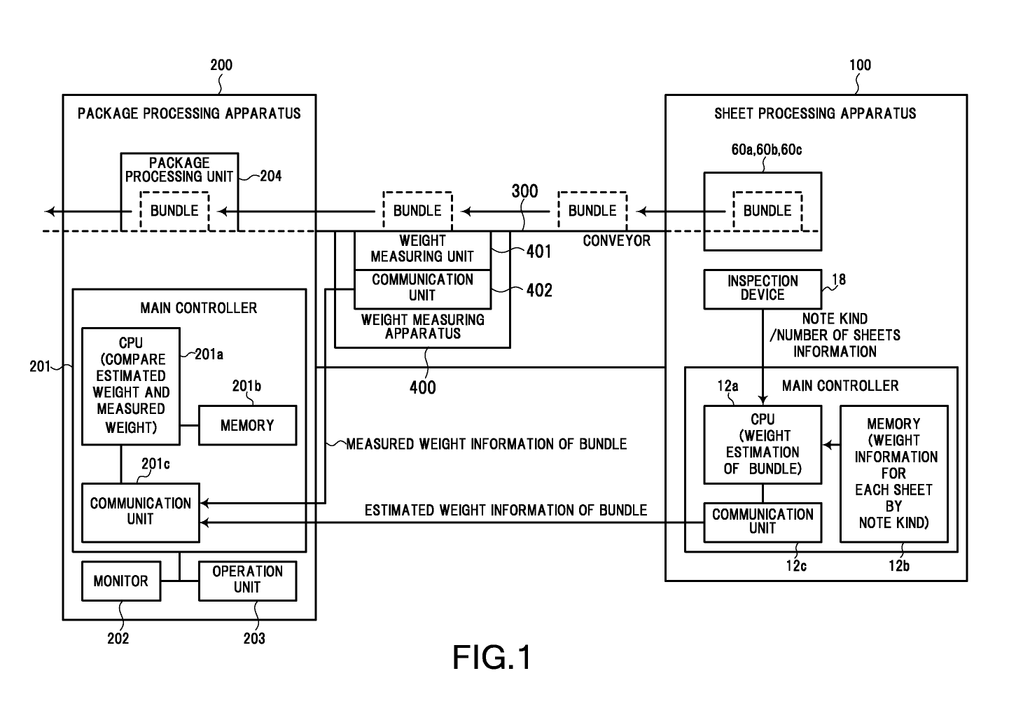

FIG. 1 is a diagram showing a schematic configuration of a sheet processing system according to an embodiment. As shown in FIG. 1, the sheet processing system is provided with a sheet processing apparatus 100, a package processing apparatus 200, a conveyor 300, and a weight measuring apparatus 400, and so on.

The sheet processing apparatus 100 sorts a plurality of sheets (a note such as a banknote) composed of a plurality of kinds, based on a denomination or a state such as a fouling degree and a direction, and stacks each of the sorted sheets into a stacker. In the present embodiment, a case to stack a plurality of denominations (fit notes) into a stacker is assumed. For example, the sheet processing apparatus assembles the sheets which have been stacked in a stacker into a bundle (100 sheets×10 sheaves), and discharges the bundle on the conveyer 300. For example, a sheaf includes a plurality of sheets of the same denomination, and a bundle including 10 sheaves includes a plurality of sheets of a plurality of kinds.

The conveyer 300 conveys a bundle of sheets (a bundle including a plurality of sheets of a plurality of kinds) to the weight measuring apparatus 400, and further the conveyer 300 conveys the bundle of sheets to the package processing apparatus 200. The weight measuring apparatus 400 measures a weight of the bundle of sheets which are conveyed on the conveyer 300.

The package processing apparatus 200 compares an estimated weight of the bundle with a measured weight of the bundle, and when the difference between the estimated weight of the bundle and the measured weight of the bundle is not more than a setting value, the package processing apparatus 200 determines that the number of the sheets by denomination included in the bundle is correct, and processes (packages) the bundle of sheets which is conveyed on the conveyer 300. In addition, when the difference between the estimated weight of the bundle and the measured weight of the bundle is larger than the setting value, the package processing apparatus 200 determines that the number of the sheets by denomination included in the bundle is not correct, and interrupts the processing (packaging) of the bundle of sheets which is conveyed on the conveyer 300. In addition, when determining that the number of the sheets by denomination included in the bundle is correct, the package processing apparatus 200 guides and displays that effect. Also when determining that the number of the sheets by denomination included in the bundle is not correct, the package processing apparatus 200 guides and displays that effect. Furthermore, when interrupting the processing (packaging) of the bundle of sheets, the package processing apparatus 200 also guides and displays that reason.

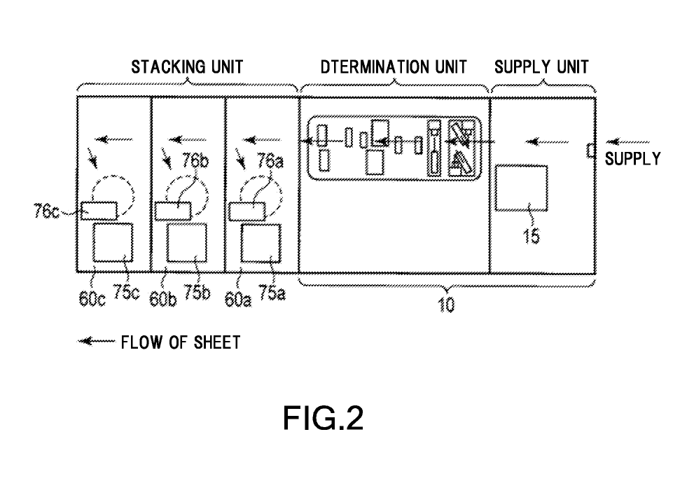

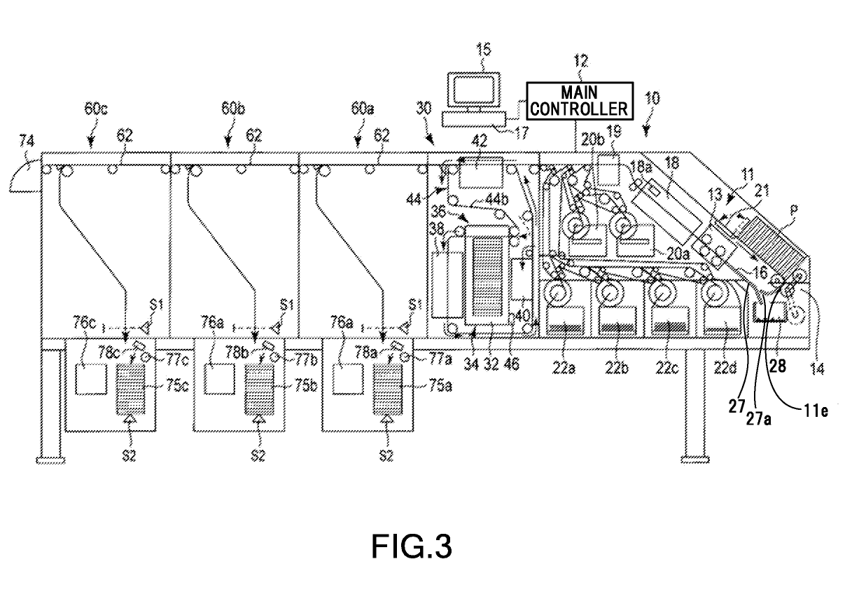

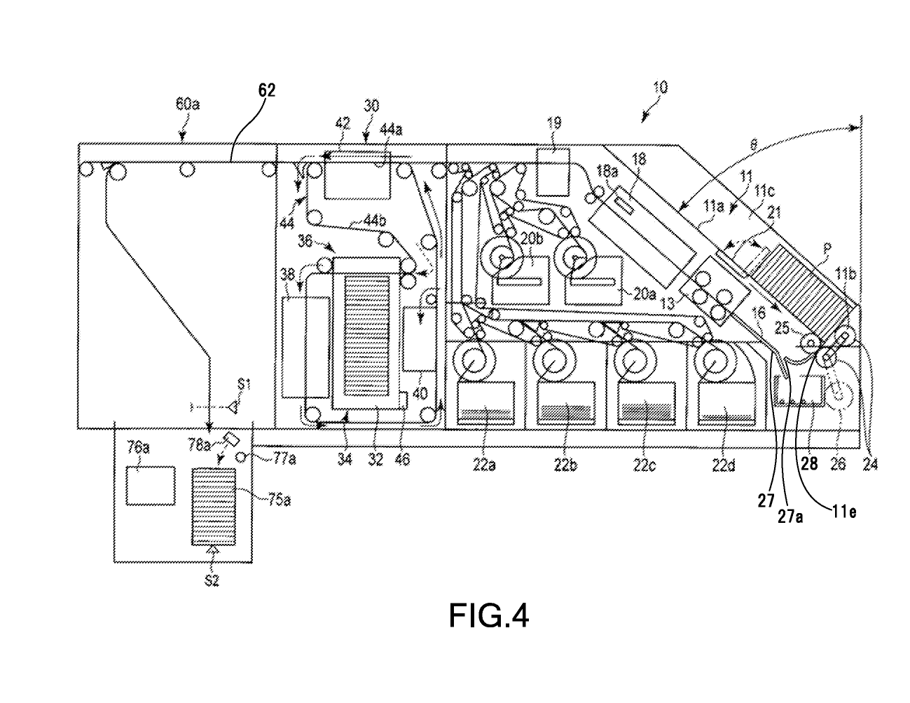

In addition, the detail of the weight prediction of a bundle, and a verification processing of the bundle based on the weight measurement of the bundle will be described later, and firstly, the sheet processing apparatus will be described. FIG. 2 is a sectional view showing schematically an example of a whole configuration of the sheet processing apparatus according to the embodiment, FIG. 3 is a sectional view showing in detail an example of the whole configuration of the sheet processing apparatus according to the embodiment, and FIG. 4 is a sectional view showing by enlargement an example of a supply/determination unit 10, a loading unit, a stacking unit of the sheet processing system according to the embodiment.

As shown in FIG. 2, the sheet processing apparatus is provided with the supply/determination unit 10 (sheet processing unit), three stacking units 60a, 60b, 60c (a plurality of sheet housing units), and these modules are arranged in a line in this order, and are electrically and mechanically coupled to each other. In the supply/determination unit 10, a main controller 12 which controls the operation of the main modules and the whole apparatus is provided.

In addition, as shown in FIG. 3, the sheet processing system may be a configuration provided with a loading unit 30. Hereinafter, the sheet processing system provided with the loading unit 30 will be described.

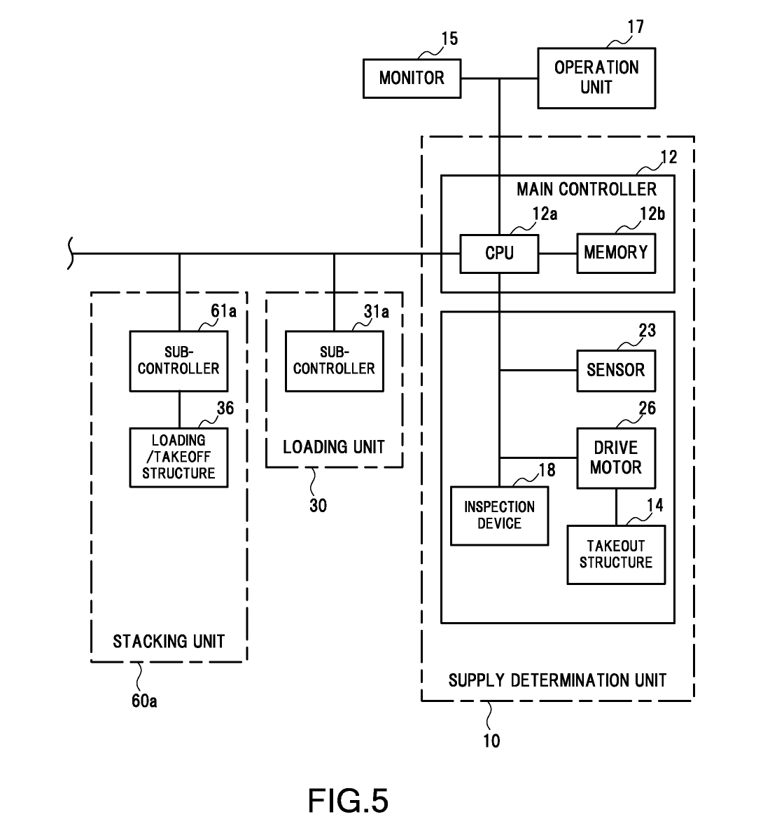

As shown in FIG. 3 and FIG. 5, the main controller 12 is provided on a control board within the supply/determination unit 10. The main controller 12 is provided with a CPU 12a which controls the operation of the respective modules and calculates the efficiency and so on of the operation state, a memory 12b which stores various data, a control program, management information and so on. As the various data, print information which is printable on a tying band, such as an operator ID, a date and time, a serial number, assignment information, a logotype of a bank, a manager's sign image, a font of a language of each country, and so on, and processing speeds of sheets in a plurality of stages and so on are stored in the memory 12b.

An operation unit 17 to input various information into the apparatus, and a monitor 15 as a display device to display the input information, and an operation state, a processing state of the apparatus, and so on are connected to the main controller 12. The loading unit 30 and the three stacking units 60a, 60b, 60c have respectively a sub-controller 31a, and a sub-controller 61a which control operations of the respective modules, and these sub-controllers are connected to the main controller 12 of the supply/determination unit 10 by means of LAN through an interface and a cable not shown. The main controller 12 is connected to a host computer not shown, and transmission and reception of information, and information arrangement are performed between the main controller 12 and the host computer.

By an operation of an operator from the operation unit 17 connected to the main controller 12, various operation settings of the processing apparatus are performed, such as setting of a transaction method such as a money reception operation and an arrangement operation, a loading processing to a loading box, an inspection processing of a sheet in a loading box, setting of a stacker to house the processed sheet P, setting of a band processing, setting of a fitness level that is a discrimination level of a sheet.

In addition, the main controller 12 calculates management information including a processing efficiency per unit time, respective processing efficiencies in a plurality of days, a processing efficiency for each of operator IDs, the total number of processed sheets, and a total operation time, in accordance with the processing information from an inspection device 18 described later, and stores the management information in the memory 12b, and displays the management information on the monitor 15.

As shown in FIG. 3 and FIG. 4, the supply/determination unit 10 has a supply unit 11 in which a plurality of sheets are loaded in a stacked state, a takeout structure 14 to take out sheets P from the supply unit 11 one by one, and a conveying path 16 to convey the sheet P taken out by the takeout structure 14. In the conveying path 16, a plurality of sets of endless conveying belts not shown are extended so as to sandwich the conveying path. The taken out sheet P is conveyed while being nipped between the conveying belts.

As shown in FIG. 4, the supply unit 11 has a bearing surface 11a which extends in the vertical direction at a slant by an angle θ, a loading surface 11b which extends from the lower end of the bearing surface 11a in an approximately orthogonal direction to the bearing surface 11a, and a pair of guide walls 11c which are erected along the both side edges of the bearing surface 11a and the loading surface 11b. At a boundary portion of the bearing surface 11a and the loading surface 11b, a takeout port 11e for taking the sheet P into the apparatus is formed. The supply unit 11 is provided at an end side of the apparatus main body of the supply/determination unit 10, and the lower portion of the supply unit 11, that is, the loading surface 11b is located in the vicinity of the lower end of the apparatus main body.

A plurality of sheets, sheets P of not less than 2000 sheets, for example, are loaded in the supply unit 11 in a stacked state. The stacked sheets P are loaded in the supply unit 11 at a slant along the bearing surface, in such a state that the sheet at the lowermost portion is loaded on the loading surface 11a, and a side edge of a long side of each of the sheets is loaded on the bearing surface 11a, for example. The stacked sheets P are taken into the apparatus through the takeout port 11e by the takeout structure 14 one by one, in the order from the lowermost sheet P.

The tilt angle θ of the bearing surface 11a is set within the range from 25 to 75 degrees, and is set to 30 to 40 degrees, for example. And the bearing surface 11a may be configured to be rotatable to the apparatus main body, and the tilt angle θ may be made adjustable.

As shown in FIG. 4, the supply unit 11 is provided with a backup plate 21 which moves the stacked sheets P to the takeout side, that is, toward the loading surface 11b. The backup plate 21 is provided so that it can be housed in the bearing surface 11a, and is provided movable along the bearing surface. The backup plate 21 is supported rotatably for the bearing surface 11a. Usually, when the sheets P of about 2000 sheets are loaded in the supply unit 11, the backup plate 21 is rotated to a position where it becomes flush with the bearing surface 11a, and is held to the position by a torsion spring and so on. When the takeout of the sheets P proceeds, and the number of the sheets decreases, that is, decreases to about 800 sheets, for example, the backup plate 21 is rotated to a position to stand orthogonally from the bearing surface 11a, and then the backup plate 21 makes contact with the uppermost stage of the stacked sheets P, and moves along with the stacked sheets P to the takeout side. By this means, the backup plate 21 can move the stacked sheets P to the takeout side, and thereby, falling of the sheets can be prevented, and the sheets can be moved to the takeout position stably, even in the state where the number of the stacked sheets P becomes small.

As shown in FIG. 4, the takeout structure 14 to take out the sheets P from the supply unit 11 one by one is provided with a plurality of pickup rollers (takeout roller) 24 which can make contact with the sheet P on the loading surface 11b, a separation roller 25 provided so as to rollingly contact to the pickup roller 24 at the takeout port 11e side, and a drive motor 26 to rotate the pickup rollers 24 at a prescribed speed.

The pickup rollers 24 rotate, and thereby the lowermost sheet P is taken out by the pickup rollers 24, and is sent to the conveying path 16 from the takeout port 11e. At this time, the second and succeeding sheets P are separated from the taken out sheet by the separation roller 25. By this means, the sheets P are taken out from the supply unit 11 one by one, and are sent to the conveying path 16.

The main controller 12 adjusts the takeout structure 14, in accordance with the amount of the stacked sheets P which have been loaded, or in accordance with an input instruction of an operator, so that an intake amount and an intake speed of the sheets are adjusted in a plurality of stages. That is, the main controller 12 adjusts the rotation speed of the pickup rollers 24 by the drive motor 26, and sets the intake amounts of 1000, 800, 600 sheets per minute. In addition, the main controller 12 adjusts the intake amount of the sheets P, in accordance with the inspection state of the inspection device 18 described later. For example, when the inspection of the sheets P can not be properly performed by the inspection device 18, the main controller 12 reduces the intake amount from 1000 sheets per minute to 800 sheets per minute. Furthermore, when double sheets takeout or short pitch of the sheets P is detected by the inspection device 18, the main controller 12 temporarily stops or reversely rotates the pickup rollers 24, to perform preventing the double sheets takeout of the sheets P, and perform normalization of the feed pitch of the sheets P.

As shown in FIG. 3 and FIG. 4, a conveying pitch correction unit 13 to correct a conveying pitch of the sheets P conveyed by the conveying path 16, and the inspection device to inspect the sheets P whose conveying pitch has been corrected one by one are arranged along the conveying path 16. The inspection device 18 is installed at upper side than the takeout port 11e of the supply unit 11, with respect to the vertical direction. The inspection device 18 detects a denomination, a shape, a thickness, front and back, authenticity, fitness, double sheets takeout and so on of the sheet P which has been sent. Here, fitness detection indicates to detect a fit note which can be recirculated and an unfit note which cannot be recirculated because dirt, damage and so on exist. Furthermore, the inspection device 18 is provided with a camera 18a that is reading means, and read outs sheet information (an image of a sheet) from the sheet P which has been sent. The inspection device 18 recognizes sheet identification information (Serial Number) included in the sheet information. The inspection device 18 may be a sensor which is disclosed in Japanese Patent Application Publication No. 2000-99791 as the reading means.

The conveying path 16 extends once downward from the takeout structure 14 and the takeout port 11e, and then extends from lower side to upper side at a slant obliquely in the vertical direction. According to the embodiment, the conveying path 16 extends approximately along the bearing surface 11a of the supply unit 11, that is, extends at a slant similarly as the bearing surface 11a. In addition, the conveying path 16 may extend obliquely upward directly from the takeout port, without coming down once from the takeout port 11e. And, the inspection device 18 is provided also at a slant obliquely along the conveying path 16.

The conveying path 16 is extended at a slant from lower side to upper side as described above, and thereby when a foreign body such as a clip, a coin, a pin, along with the sheet from the supply unit 11 are taken into the conveying path 16, the foreign body drops along the conveying path 16 to the lowermost portion of the conveying path. By this means, the foreign body is excluded before entering the inspection device 18, to prevent beforehand the damage of the inspection device 18 due to the foreign body.

As shown in FIG. 4, a discharge port 27a is formed in a guide plate 27 defining the conveying path 16, at the lowermost portion of the conveying path 16, and a foreign body collection unit is provided below the discharge port 27a. The foreign body collection unit is composed of a collection box 28 which can be drawn from the apparatus main body, for example. The foreign body which drops along the conveying path 16 is discharged from the discharge port 27a, and collected in the collection box 28.

As shown in FIG. 3 and FIG. 4, in the supply/determination unit 10, two rejection units 20a, 20b are provided along the conveying path 16, and a plurality of stackers 22a, 22b, 22c, 22d, each for stacking a sheet are arranged in a line. The sheets P which have passed the inspection device 18 are sorted into a reject note and a processed note by a gate not shown. The reject note is a note which has been discriminated as a counterfeit note, or a note which has been discriminated as an undiscriminatable note due to fold, break, skew, double sheets takeout, by the inspection device 18. The skew is a state where the sheet P is at a slant obliquely for the direction orthogonal to the conveying direction. The reject notes are sorted and stacked into the rejection unit 20a or 20b. The reject notes stacked in the rejection unit 20a or 20b, except the counterfeit note, are set in the supply unit 11 again for re-takeout, or are counted in count data by manual input. The inspection result by the inspection device 18, such as a processed amount of money, the number of sheets is sent to the main controller 12, and stored therein, and displayed on the monitor 15.

In addition, the processed note is a note in the case where the sheet P discriminated by the inspection device 18 is a genuine note and a fit note, or a genuine note and an unfit note. The processed sheets are sent to the stackers 22a to 22d, and stacked therein. For example, the processed sheets are sorted and stacked in any of the stackers 22a to 22d corresponding to the respective denominations, and the unfit notes are collectively stacked in one stacker.

The conveying path 16 connects to the loading unit 30 described later. When sheets are loaded in a loading box by the loading unit 30, a part or all of the processed notes inspected by the inspection device 18 of the supply/determination unit 10 are sent to the loading unit 30 through the conveying path 16.

In addition, the supply/determination unit 10 is provided with a drive mechanism and a power source not shown for driving the takeout structure 14, the inspection device 18, the conveying structure and so on, and various sensors.

As shown in FIG. 3 and FIG. 4, the loading unit 30 is provided with a mounting portion 34 in which a loading box 32 such as an ATM cassette taken out from an automated teller machine (ATM), and a loading cassette is detachably mounted, a loading/takeoff structure 36 which loads a sheet into the loading box 32, or takes out a sheet from the loading box 32, an inspection device 38, a reject box 40, an aligning structure 42, and a conveying path 44 to convey a sheet through these. In the conveying path 44, a plurality of sets of endless conveying belts are extended so as to sandwich the conveying path. The sheet is conveyed while being nipped between the conveying belts. The conveying path 44 has a first conveying path 44a which continues from the conveying path 16 of the supply/determination unit 10 to the stacking unit 60a, and a second conveying path 44b which passes from the first conveying path, the vicinity of the mounting portion 34, the inspection device 38, and the reject box 40, and returns to the first conveying path.

As the loading box 32 which is mounted in the mounting portion 34, there is a loading box capable of only loading (deposit) of a sheet, a loading box capable of only takeout (payment) of a sheet, or a loading box capable of loading and takeout (deposit and payment) of a sheet. Here, the loading box 32 is configured to be capable of loading a lot of sheets, and capable of taking out the sheet from this loading box. In addition, the loading box 32 is provided with a sensor to detect loading and takeout of a sheet, and a memory to store information such as a denomination of a loaded sheet, an amount of money (an amount in hand), operator information, an ID (a branch number, an index indicating what loading box this is) of the loading box 32, a machine number.

The loading/takeoff structure 36 of the loading unit 30 has a takeout roller to take out sheets from the loading box 32 one by one, a loading roller to load a sheet into the loading box 32, and a conveying roller and so on.

The inspection device 38 detects a denomination, a shape, a thickness, front and back, authenticity, fitness, double sheets takeout, a serial number of the sheet and so on of the sheet taken out from the loading box 32. Here, fitness detection indicates to detect a fit note which can be recirculated and an unfit note which cannot be recirculated because dirt, damage and so on exist. The unfit note includes a sheet to which a tape has been pasted. Authenticity detection can use magnetic detection, image detection, or fluorescence detection which applies fluorescence to a sheet and reads the reflected light. In addition, the inspection device 38 counts the taken-out sheets, and calculates the number of the sheets and an amount in hand. The inspection result (including information of the processed number by denomination) inspected by the inspection device 38 is sent to the main controller 12, and stored therein, and displayed on the monitor 15.

The reject box 40 is provided at the downstream side of the inspection device 38, with respect to the conveying direction of the sheet. The sheets P which have passed through the inspection device 38 are sorted into a reject note and a processed note by a gate not shown. The reject note is a note which has been discriminated as a counterfeit note, or a note which has been discriminated as an undiscriminatable note due to fold, break, skew, double sheets takeout by the inspection device 38. The reject note is sent to the reject box 40, and stacked. In addition, any one or a plurality of the stackers 22a-22d of the supply/determination unit 10 have previously been set as reject boxes, under the control of the main controller 12, and the reject note discharged from the loading unit 30 may be sent to the reject box of the supply/determination unit 10 and may be stacked therein. Furthermore, out of the reject notes which have passed through the inspection device 38, the reject note which has been discriminated as a counterfeit note and, another reject note may be stacked separately in the different stackers.

The processed note is a note in the case where the sheet P discriminated by the inspection device 38 is a genuine note and a fit note, or a genuine note and an unfit note. The fit note is returned to the loading box 32 through the conveying path 44b and aligning structure 42, and loaded in the loading box 32 by the loading/takeoff structure 36. Any one or a plurality of the stackers 22a-22d of the supply/determination unit 10 have previously been set as unfit note boxes, under the control of the main controller 12, and the unfit note discharged from the loading unit 30 is sent to the unfit note box of the supply/determination unit 10 and stacked therein.

The fit notes taken out from the loading box 32 may be stacked in the stackers 22a-22d of the supply/determination unit 10 for each denomination, by a predetermined optional designated number of the sheets. In addition, when the number of sheets to be stacked in the loading box 32, that is 2000 sheets, for example, is set, a shortage portion can be recognized from the number of fit notes detected by the inspection device 38 as described above, and the sheets of the number of the shortage portion are supplied from the supply/determination unit 10 to the loading unit 30, and are loaded in the loading box 32 through the aligning structure 42 and the conveying path 44. The loading box 32 is mounted in the mounting portion 34 of the loading unit 30, and thereby, since an amount in hand of the sheets in the loading box 32 is automatically sent to the main controller 12, when judging that the sent amount in hand is insufficient for the desired amount in hand, the main controller may automatically supply sheets of the shortage portion from the supply/determination unit 10 to the loading box 32 to load the sheets therein.

As shown in FIG. 3 and FIG. 4, the stacking unit 60a is provided with a conveying path 62 which links to the conveying path 44a of the loading unit 30, a stacking device 75 to stack the sheet which has been sent through this conveying path 62, a sensor S1 to detect the sheet to be discharged to the stacking device 75a, a display device 76a to display information relating to the sheet stacked in the stacking device 75a, and an indicator 77a to guide that the sheet has properly been stacked in the stacking device 75a.

As shown in FIG. 3, the other stacking units 60b, 60c are composed similarly as the stacking unit 60a, and the respective conveying paths 62 of the stacking units 60a, 60b, 60c extend while linking to each other. And the sheet P is sent form the supply/determination unit 10 or the loading unit 30 to an optional one of the stacking units 60a, 60b, 60c, and is stacked therein.

A safety pocket 74 is provided at the lowermost downstream of the whole modules. When there is a sheet which has not been processed during conveyance in the respective modules, this sheet is discharged to the safety pocket 74, and is evacuated from the apparatus.

Next, the cooperation of the sheet processing apparatus 100, the package processing apparatus 200, the conveyor 300, and the weight measuring apparatus 400 will be described with reference to FIG. 1.

The sheet processing apparatus 100 is provided with the main controller 12, and the main controller 12 is provided with a CPU 12a, a memory 12b, a communication unit 12c. The memory 12b stores information of a weight for each sheet by denomination of the sheet, for example.

As described above, the main controller 12 receives the information of the number of the sheets by denomination from the inspection device 38, and manages the information of the number of the sheets by denomination stacked in one stacker, and furthermore, manages also the information of the number of the sheets by denomination discharged from one stacker as a bundle. For example, the main controller 12 may manage information of the number of the sheets by denomination included in a bundle, and may manage the number of sheaves included in a bundle, information of a denomination of each sheaf, and information of the number of the sheets included in each sheaf.

Furthermore, the main controller 12 estimates a weight of a bundle (hereinafter, estimated weight information), based on the information of a weight for each sheet by denomination of the sheet stored in the memory 12b, and the information of the number of the sheets by denomination included in a bundle (or the number of sheaves included in a bundle, the information of a denomination of each sheaf, and the information of the number of the sheets included in each sheaf).

The sheet processing apparatus 100 discharges a bundle including a plurality of sheets of a plurality of denominations to the conveyor 300, and transmits the estimated weight information of the bundle to the package processing apparatus 200 through the communication unit 12c.

The conveyor 300 conveys the bundle to the weight measuring apparatus 400, and the conveyor 300 further conveys the bundle to the package processing apparatus 200.

The weight measuring apparatus 400 is provided with a weight measuring unit 401, a communication unit 402. The weight measuring unit 401 measures a weight of the bundle conveyed by the conveyor 300. The communication unit 402 transmits the weight (hereinafter, measured weight information) of the bundle measured by the weight measuring unit 401 to the package processing apparatus 200.

The package processing apparatus 200 is provided with a main controller 201, a monitor 202, an operation unit 203, a package processing unit 204 and so on. The main controller 201 is provided with a CPU 201a, a memory 201b, a communication unit 201c. The main controller 201 receives the estimated weight information from the sheet processing apparatus 100 through the communication unit 201c. In addition, the main controller 201 receives the measured weight information from the weight measuring apparatus 400.

The main controller 201 compares the estimated weight information and the measured weight information, and verifies the number of sheets of a bundle based on the comparison result. For example, when the difference between the estimated weight and the measured weight exceeds a setting value, the main controller 201 judges that the number of the sheets included in the conveyed bundle is not correct, and stops the succeeding sheet processing. In addition, when the difference between the estimated weight and the measured weight is not more than the setting value, the main controller 201 judges that the number of the sheets included in the conveyed bundle is correct, and processes (packages) the bundle. For example, 5% of the estimated weight is set as the setting value. When a defined bundle includes 10 sheaves, and an actual bundle includes only 9 sheaves, wanting of the sheaf can be detected by the above-described setting value.

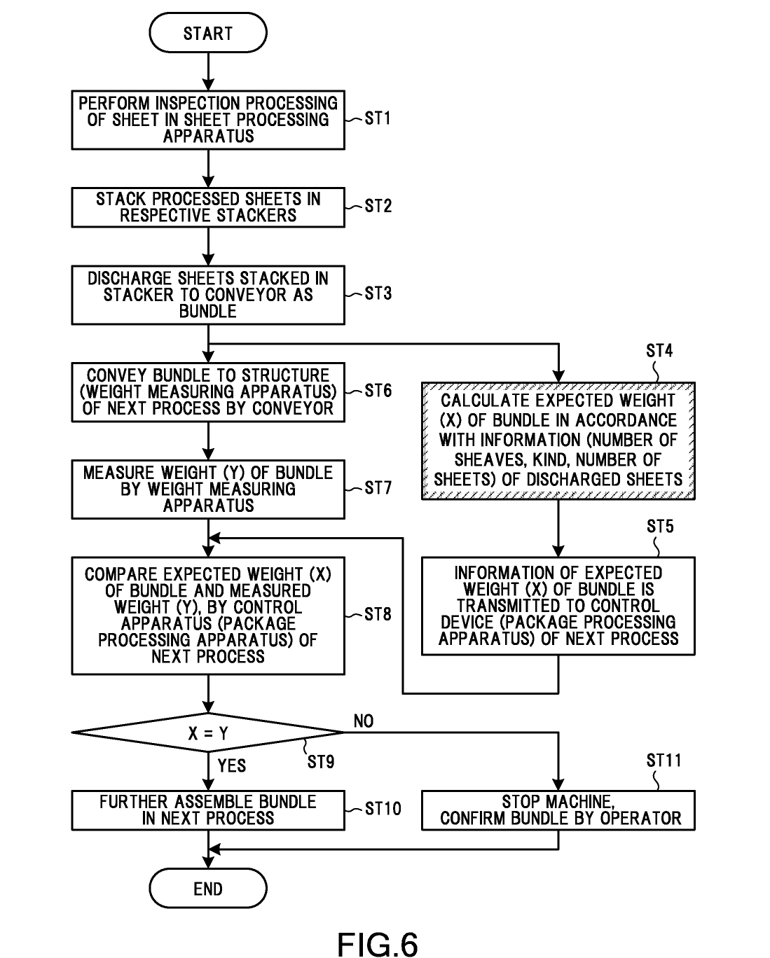

Furthermore, weight estimation of a bundle, weight measurement of the bundle, and package processing control of the bundle will be described with reference to a flow chart of FIG. 6.

As described above, the sheet processing apparatus 100 executes an inspection processing of sheets (ST1), and stacks the processed sheets to each of the stackers (ST2). The sheet processing apparatus 100 manages a denomination of a sheet, the number of sheets by denomination and so on, and also manage information of a bundle discharged from each of the stackers. That is, the sheet processing apparatus 100 manages denominations of the sheets included in the bundle, and the number of the sheets by denomination, and so on. Or, the sheet processing apparatus 100 manages the number of sheaves composing a bundle, a denomination of the sheets included in each sheaf, and the number of sheets by denomination, and so on. The sheet processing apparatus discharges the sheets stacked in a stacker in the form of a bundle to the conveyor 300 (ST3).

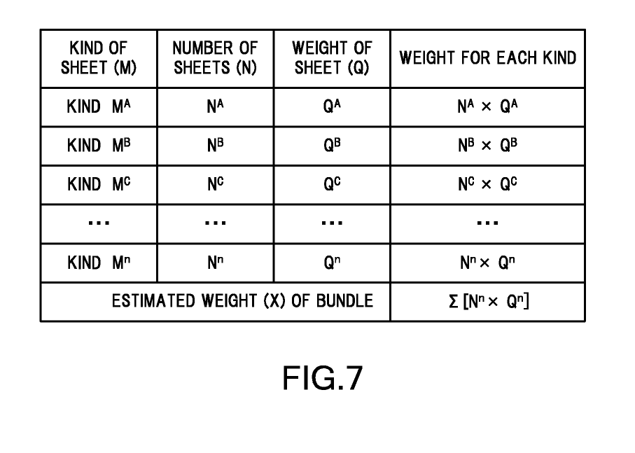

In addition, the sheet processing apparatus 100 estimates a weight of a bundle, based on the information of a weight for each sheet by denomination of the sheets stored in the memory 12b, and information of the number of the sheets by denomination included in a bundle (ST4). FIG. 7 is a diagram showing a calculation example of an estimated weight of a bundle. The sheet processing apparatus 100 transmits estimated weight information to the package processing apparatus 200 that is a control apparatus (ST5).

The conveyor 300 conveys the bundle to a structure of the next process, that is, the weight measuring apparatus 400 (ST6). The weight measuring apparatus 400 measures a weight of the bundle conveyed by the conveyor 300 (ST7), and outputs measured weight information that is the measurement result of the weight of the bundle to the package processing apparatus 200.

The package processing apparatus 200 compares the estimated weight information and the measure weight information (ST8), and when the measured weight coincides with the estimated weight, or the difference between the estimated weight and the measured weight is not more than a setting value (ST9, YES), the package processing apparatus 200 permits the processing of the next process, and packages the bundle in the next process (ST10). When the measured weight does not coincide with the estimated weight, or the difference between the estimated weight and the measured weight exceeds the setting value (ST9, NO), the package processing apparatus 200 stops the sheet processing, and outputs guidance information such as warning with the monitor 202 (ST11). Or, when the measured weight does not coincide with the estimated weight, or the difference between the estimated weight and the measured weight exceeds the setting value, the package processing apparatus 200 may house the relevant bundle to a reject pocket, without stopping the sheet processing, and may output guidance information such as warning of that effect with the monitor 202, or may inform that effect with an LED and so on.

In addition, in the present embodiment, a case has been described in which the sheet processing apparatus 100 calculates the estimated weight information, but the sheet processing apparatus 100 transmits information of the number of the sheets by denomination included in a bundle, and the package processing apparatus 200 receives the information of the number of the sheets by denomination included in a bundle, and may calculate estimated weight information from the received information.

In addition, when stacking sheets, the sheet processing apparatus 100 assumes a weight of the sheets of each sheaf, and may transmit a sum of the weights of respective sheaves, as the information of the bundle of sheets, to the package processing apparatus 200.

In addition, a bundle to be conveyed on the conveyor 300 is photographed by a camera and so on, an image of the bundle is analyzed, bands bound on sheaves included in the bundle are detected, the number of sheaves included in the bundle conveyed on the conveyor 300 is detected from the detection result of the bands, and the number of the sheaves (the information of the bundle) transmitted from the sheet processing apparatus 100) included in the bundle discharged from the sheet processing apparatus 100, and the number of the sheaves included in the bundle to be conveyed by the conveyor 300 are collated, and thereby the bundle can also be verified (the number of sheets included in the bundle is verified).

Hereinafter, the present embodiment will be summarized.

The sheet processing apparatus estimates a weight of a bundle, from information of a weight for each sheet by denomination of the sheet, and information of the number of the sheets by denomination included in the bundle to be discharged, and transmits estimated weight information to the package processing apparatus 200. Or, the sheet processing apparatus transmits information of the number of the sheets by denomination included in a bundle to be discharged to the package processing apparatus 200, and the package processing apparatus 200 estimates a weight of the bundle, from the information of a weight for each sheet by denomination of the sheet, and the information of the number of the sheets by denomination included in the bundle to be discharged. The package processing apparatus 200 compares measured weight information obtained by actually measuring the bundle and the estimated weight information, and thereby can accurately verify the number of the sheets included in the bundle. By this means, even if sheets of a plurality of kinds with different weights mixedly exist in a bundle, the number of the sheets included in the bundle can be accurately verified.

In addition, the measured weight information and the estimated weight information are compared, and the bundle can also be verified in accordance with whether the difference between the measured weight information and the estimated weight information exceeds a setting value, or is not more than the setting value. If the setting value is set to a small value, the bundle can be verified with higher accuracy, and if the setting value is set to a relatively large value, excess and deficiency of the sheaves can be verified.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet processing system comprising:
estimation means which, based on bundle information relating to a number of sheets by denomination of a plurality of the sheets included in a bundle, and weight information of the sheets by denomination, estimates a weight of the bundle, to output estimated weight information;
measurement means for measuring a weight of the bundle, to output measured weight information;
comparison means for comparing the estimated weight information and the measured weight information; and
control means for controlling a processing of the bundle, based on a comparison result of the estimated weight information and the measured weight information.

2. The system of claim 1, wherein:
the estimation means, based on the bundle information relating to a number of sheets by denomination of a plurality of the sheets included in respective sheaves composing the bundle, and the weight information, estimate weights of the respective sheaves, and estimates the weight of the bundle from a sum of the estimated weights of the respective sheaves.

3. The system of claim 2, wherein:
the control means, when a difference between the estimated weight information and the measured weight information exceeds a setting value, stops a processing of the bundle.

4. The system of claim 3, wherein:
the control means, when detecting excess and deficiency of the sheaves composing the bundle, based on the difference between the estimated weight information and the measured weight information, stops the processing of the bundle.

5. The system of claim 4, further comprising:
a sheet processing apparatus which discriminates the denomination of the sheet, counts a number of the sheets by denomination, and stacks a plurality of the sheets;
conveying means for conveying the bundle of a plurality of the stacked sheets;
a weight measuring apparatus to measure the weight of the bundle to be conveyed; and
a bundle processing apparatus to process the bundle to be conveyed,
wherein:
the sheet processing apparatus comprises the estimation means and first communication means;
the first communication means transmits the estimated weight information to the bundle processing apparatus;
the weight measuring apparatus comprises the measurement means and second communication means;
the second communication means transmits the measured weight information to the bundle processing apparatus;
the bundle processing apparatus comprises the comparison means, the control means and third communication means; and
the third communication means receives the estimated weight information and the measured weight information, and outputs the estimated weight information and the measured weight information to the comparison means.

6. The system of claim 5, wherein:
the sheet processing apparatus comprises storage means, and the storage means stores the weight information of the sheets by denomination.

7. The system of claim 6, wherein:
the sheet processing apparatus manages the number of sheets by denomination of the sheets included in the respective sheaves composing the bundle, and when the control means detects difference between a number of the sheaves composing the bundle before conveyance, and a number of the sheaves composing the bundle after conveyance, based on the comparison result of the estimated weight information and the measured weight information, the control means stops the processing of the bundle.

8. The system of claim 7, wherein: when the control means detects coincidence between the number of the sheaves composing the bundle before conveyance, and the number of the sheaves composing the bundle after conveyance, based on the comparison result of the estimated weight information and the measured weight information, the control means permits the package processing of the bundle.

9. A sheet processing method comprising:
estimating a weight of a bundle, to output estimated weight information, based on bundle information relating to a number of sheets by denomination of a plurality of the sheets included in the bundle, and weight information of the sheets by denomination,
measuring a weight of the bundle, to output measured weight information;
comparing the estimated weight information and the measured weight information; and
controlling a processing of the bundle based on a comparison result of the estimated weight information and the measured weight information.
